(19) United States
(12) Patent Application Publication
(10) Pub. No.: US 2025/0333073 A1
(43) Pub. Date: Oct. 30, 2025

(54) VEHICLE AND CONTROL METHOD FOR PREVENTING TRAFFIC ACCIDENTS USING SHORT-RANGE WIRELESS COMMUNICATION

(71) Applicants: HYUNDAI MOTOR COMPANY, SEOUL (KR); KIA CORPORATION, SEOUL (KR)

(72) Inventors: Dong Hoon LEE, Suwon-si (KR); Jin Kyeom CHO, Suwon-si (KR); Sun Woo KIM, Seoul (KR); Han Seung MYOUNG, Taean-eup (KR); Dong Hyeon WOO, Daegu (KR)

(21) Appl. No.: 18/885,546

(22) Filed: Sep. 13, 2024

(30) Foreign Application Priority Data
Apr. 29, 2024 (KR) 10-2024-0057009

(51) Int. Cl. B60W 50/14; B60Q 9/00; B60W 10/18; B60W 30/09; B60W 30/095; G01S 13/02; G01S 13/931; H04W 4/44; H04W 4/80; H04W 4/90

(52) U.S. Cl. CPC B60W 50/14; B60Q 9/008; B60W 10/18; B60W 30/09; B60W 30/0956; G01S 13/0209; G01S 13/931; H04W 4/44; H04W 4/80; H04W 4/90; B60W 2050/143; B60W 2050/146; B60W 2554/4041; B60W 2554/4046; B60W 2556/45

(57) ABSTRACT

Proposed is a method of controlling a vehicle for preventing traffic accidents by sensing objects using a wireless communication technology and by outputting a warning in accordance with a preset reference, and a vehicle using the method. The method of controlling a vehicle includes sensing whether there is an object, which can be positioned, around a subject vehicle based on a short-range wireless communication protocol that supports spatial positioning and direction recognition, and outputting a warning in response that an object is sensed around the subject vehicle and at least one of position and behavior of the sensed object satisfies a preset warning condition.

### CROSS REFERENCE TO RELATED APPLICATION

The present application claims priority to Korean Patent Applications No. 10-2024-0057009, filed on Apr. 29, 2024 the entire contents of which are incorporated herein for all purposes by this reference.

### BACKGROUND

### Technical Field

The present disclosure relates to a vehicle providing a function for preventing traffic accidents using a short-range wireless communication technology, and a method of controlling the vehicle.

### Description of Related Art

When there is a vehicle parked or stopped at a side on a road, a blind spot may be made by the parked or stopped vehicle. Accordingly, when a pedestrian rushes in front of a moving vehicle across between parked or stopped vehicles, the driver of the moving vehicle cannot recognize the pedestrian due to such a blind spot, so a dangerous situation may occur. In particular, children and elders are short in comparison to parked vehicles in many cases, so there is a problem that even though the driver of a moving vehicle sufficiently carefully drives, it is difficult to recognize children or elders hidden by parked or stopped vehicles. Accordingly, it is required to develop a technology that prevents pedestrian accidents by sensing pedestrians in order to solve this problem.

The description provided above as a related art of the present disclosure is merely to help understand the background of the present disclosure and should not be construed as being included in the related art known by those skilled in the art.

### SUMMARY

The present disclosure has been made to solve the problem of traffic accidents due to parked or stopped vehicles. In particular, children and elders are short in comparison to parked vehicles in many cases and it is more difficult for drivers to recognize them, so an objective of the present disclosure is to provide a vehicle for solving this problem and a method of controlling the vehicle.

The technical subjects to implement in the present disclosure are not limited to the technical problems described above and other technical subjects that are not stated herein will be clearly understood by those skilled in the art from the following specifications.

A method of controlling a vehicle according to an embodiment of the present disclosure includes: sensing whether there is an object, which can be positioned, around a subject vehicle based on a short-range wireless communication protocol that supports spatial positioning and direction recognition; and in response that an object is sensed around the subject vehicle, determining whether at least one of position and behavior of the sensed object satisfies a preset warning condition.

As an embodiment, The method further comprising outputting a warning to an interior or an exterior of the subject vehicle or to a surrounding object in response that the present warning condition is satisfied.

As an embodiment, the outputting of a warning to an interior may include outputting a warning through at least one of a display or a sound device of the subject vehicle.

As an embodiment, the outputting of a warning to an exterior may include outputting a warning by controlling a mirror, a lighting device, a horn, or the like of the subject vehicle.

As an embodiment, the outputting of a warning to an object may include transmitting a warning output request signal to at least one of the sensed objects or a surrounding vehicle based on the communication protocol of the subject vehicle.

As an embodiment, the short-range wireless protocol may include Ultra-Wide Band (UWB).

As an embodiment, the object may have a UWB tag and the subject vehicle may have one or more UWB anchors.

As an embodiment, the sensing may further include: determining priority in accordance with a preset reference based on position and behavior of a plurality of objects in response that the plurality of objects is sensed; and determining whether the preset warning condition is satisfied based on an object having highest priority.

As an embodiment, the preset condition may be satisfied in at least one case of in response that the object moves from a preset safety area around the subject vehicle toward a preset danger area around the subject vehicle, in response that the object is in the danger area, and in response that the object moves toward a lane from the danger area.

As an embodiment, the method may further include instructing the subject vehicle to brake in response that the preset warning condition is satisfied.

A vehicle according to an embodiment of the present disclosure includes: a communication terminal configured to sense whether there is an object, which can be positioned, around the vehicle based on a short-range wireless communication protocol that supports spatial positioning and direction recognition; and a controller configured to, in response that an object is sensed around the vehicle, determine whether at least one of position and behavior of the sensed object satisfies a preset warning condition.

As an embodiment, the vehicle further comprising an output unit, wherein the controller may perform control such that a warning is output to an interior or an exterior of the vehicle or the warning is output to the object through the output unit in response that the preset warning condition is satisfied.

As an embodiment, the output unit may include at least one of a display or a sound device provided in the interior of the vehicle.

As an embodiment, the output unit may include at least one of a mirror, a lighting device, or a horn provided on the exterior of the vehicle.

As an embodiment, the communication terminal may be further configured to output a warning output request signal to the sensed object based on the communication protocol.

As an embodiment, the short-range wireless protocol may include Ultra-Wide Band (UWB).

As an embodiment, the object may have a UWB tag and the vehicle may have one or more UWB anchors.

As an embodiment, in response that a plurality of objects is sensed, the controller may be further configured to determine priority in accordance with a preset reference based on position and behavior of each of the plurality of objects and determine whether the preset warning condition is satisfied based on an object having highest priority.

As an embodiment, the controller may be further configured to divide a surrounding of the vehicle into a danger area and a safety area and may determine that the preset warning condition is satisfied in at least one case of in response that the object moves toward the danger area from the safety area, in response that the object is in the danger area, and when the object moves toward a lane from the danger area.

As an embodiment, the controller may be further configured to sense the object when the vehicle is in stop or park and determine whether the preset warning condition is satisfied for the sensed object.

According to an embodiment of the present disclosure, there may be provided an effect of preventing a traffic accident by sensing in advance a pedestrian hidden by a parked vehicle using a short-range wireless communication technology and by generating a warning to the driver of a vehicle moving around the parked vehicle or the pedestrian.

The effects of the present disclosure are not limited to the effects described above and other effects can be clearly understood by those skilled in the art from the following description.

### BRIEF DESCRIPTION OF THE DRAWINGS

The above and other objectives, features and other advantages of the present disclosure will be more clearly understood from the following detailed description when taken in conjunction with the accompanying drawings, in which:

FIG. 1 shows an example of a vehicle configuration and an object that can be applied to various embodiments;

FIG. 2 is a view illustrating a method of preventing a traffic accident when a vehicle an embodiment of the present disclosure is in park;

FIG. 3 is a view illustrating a method of determining the distance between a tag and an anchor by means of a controller according to an embodiment;

FIG. 4 is a view illustrating a method of determining the position and behavior of a tag through triangulation by means of a controller according to an embodiment;

FIG. 5 is a view illustrating a method of determining surrounding danger area and safety area by means of a controller of a parked vehicle according to an embodiment;

FIG. 6 is a view illustrating a method of determining the priority of a plurality of objects around a vehicle by means of a controller according to an embodiment;

FIG. 7 is a view illustrating a method of determining a danger area and a safety area around a moving vehicle by means of a controller according to an embodiment;

FIG. 8 shows a method of outputting an interior warning in accordance with an embodiment of the present disclosure;

FIG. 9 shows a method of outputting an exterior warning in accordance with an embodiment of the present disclosure;

FIG. 10 shows a method of requesting output of a warning to a surrounding object by means of a vehicle according to an embodiment;

FIG. 11 is view illustrating a method of outputting a warning when there is an object in front of a vehicle according to an embodiment when the vehicle is moving;

FIG. 12 is view illustrating a method of outputting a warning when there is an object around a vehicle according to an embodiment when the vehicle is moving;

FIG. 13 is a view illustrating a method of requesting a traffic light to output a warning by means of a vehicle according to an embodiment; and

FIG. 14 is a flowchart of a method in which a vehicle according to an embodiment senses an object and prevents a traffic accident.

### DETAILED DESCRIPTION

Hereafter, embodiments of the present disclosure will be described in detail with reference to the accompanying drawings and the same or similar components are given the same reference numerals regardless of the numbers of figures and are not repeatedly described. Terms “module” and “unit” that are used for components in the following description are used only for the convenience of description without having discriminate meanings or functions. In the following description, if it is decided that the detailed description of known technologies related to the present disclosure makes the subject matter of the embodiments described herein unclear, the detailed description is omitted. Further, the accompanying drawings are provided only for easy understanding of embodiments disclosed in the specification, the technical spirit disclosed in the specification is not limited by the accompanying drawings, and all changes, equivalents, and replacements should be understood as being included in the spirit and scope of the present disclosure.

Terms including ordinal numbers such as “first” and “second” may be used to describe various components, but the components are not to be construed as being limited to the terms. The terms are used only to distinguish one component from another component.

It is to be understood that when one element is referred to as being “connected to” or “coupled to” another element, it may be connected directly to or coupled directly to another element or be connected to or coupled to another element with the other element therebetween. On the other hand, it should be understood that when one element is referred to as being “connected directly to” or “coupled directly to” another element, it may be connected to or coupled to another element without the other element therebetween.

Singular forms are intended to include plural forms unless the context clearly indicates otherwise.

It will be further understood that the terms “comprise” or “have” used in this specification specify the presence of stated features, steps, operations, components, parts, or a combination thereof, but do not preclude the presence or addition of one or more other features, numerals, steps, operations, components, parts, or a combination thereof.

A unit or a control unit is only a term that is generally used to name a controller that controls specific functions rather than mean a generic function unit. For example, each control unit may include a communication device that communicates with another control unit or a sensor to control corresponding functions, a memory that stores an operating system or logic commands and input/output information, and one or more processors that perform determination, calculation, decision, etc. for controlling the corresponding functions.

Embodiments of the present disclosure proposes a method of controlling a vehicle that determines whether a preset warning condition is satisfied from the position and behavior of an object such as a pedestrian, which has a short-range communication device, around the vehicle when sensing the object, and outputs warnings inside and outside the vehicle and requests output of a warning to the object when the warning condition is satisfied. Since it is required to be able to determine the position and behavior of an object having a short-range communication device when sensing the object, a short-range wireless communication protocol that supports spatial positioning and direction recognition may be applied. Ultra-Wide Band (UWB) may be exemplified as the short-range wireless communication protocol. UWB means a short-range wireless communication protocol that uses high-frequency band radio waves with a very large width in a frequency domain. UWB has advantages of precise spatial positioning, precise direction recognition, low power consumption, high security, etc., as compared with other short-range wireless communication protocols. It is assumed in the following description that a short-range wireless communication protocol that supports spatial positioning and direction recognition is UWB, but this is only for the convenience of description and any communication protocols such as Bluetooth Low-Energy (BLE) can be applied to embodiments of the present disclosure as long as they can achieve spatial positioning and direction recognition other than UWB.

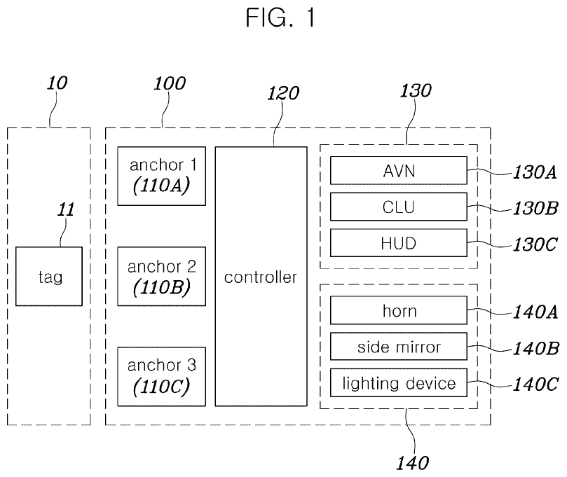

Hereafter, an example of a vehicle configuration that can be applied to embodiments is described with reference to FIG. 1.

FIG. 1 shows an example of a vehicle configuration and a short-range communication device that can be applied to various embodiments.

Referring to FIG. 1, the present disclosure can be implemented through a short-range communication device 10 and a vehicle 100.

The short-range communication device 10 may be worn on or carried by an object and may include a tag 11 that supports a short-range wireless communication protocol (e.g., UWB). The object may be a concept that includes a pedestrian including a child and an elder, and even a pet.

For example, the short-range communication device 10 may include a smart terminal, a wearable device, etc., but is not limited thereto. Since an object such as a pedestrian carries/wears the short-range communication device 10, recognizing/determining the position of an object may mean determining the position of the short-range communication device 10 in the following description.

The vehicle 100 according to an embodiment may include anchors 110A, 110B, and 110C, a controller 120, an interior output unit 130, and an exterior output unit 140.

The anchors 110A, 110B, and 110C are devices that can transmit and receive a short-range communication protocol (i.e., UWB) signal. For example, an anchor can exchange a UWB signal with the tag 11 of the short-range communication device 10. When the vehicle 100 is equipped with three or more anchors, spatial positioning and direction recognition for the tag 11 can become more accurate through triangulation to be described below.

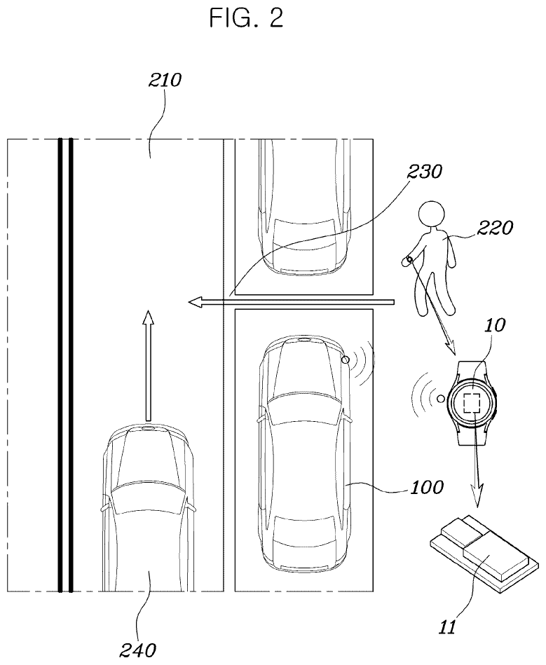

The controller 120 can determine the distances between the anchors 110A, 110B, and 110C and the short-range communication device 10 having the tag 11 based on information obtained from the anchors 110A, 110B, and 110C, and can determine the relative position of the object from the vehicle 100 by applying triangulation to the distances. When preset conditions are satisfied, the controller 120 can control at least one of the interior warning output units and the exterior warning output unit to output a warning based on the distance between the object and the vehicle and the position of the object. According to an embodiment, when the vehicle 100 is stopped and a preset condition is satisfied, the controller 120 can control the communication device, etc. of the vehicle 100 to request output of a warning to the tag 11 of a surrounding object and another surrounding moving vehicle (e.g., 220 in FIG. 2 to be described below). According to an embodiment, when the vehicle 100 is moving and the preset condition is satisfied, the controller 120 can control the behavior of the moving vehicle 100. For example, controlling the behavior of the vehicle 100 may include deceleration control such as emergency braking, but is not necessarily limited thereto. As another example, behavior control may further include steering control.

The interior output unit 130 can output a warning to the users in the vehicle 100 in accordance with an instruction from the controller. For example, the interior output unit 130 may include an Audio/Video/Navigation (AVN) terminal 130A that can output a warning in the vehicle using a voice, a sound, a display, etc., a cluster unit (CLU) 130B, a Head-Up Display (HUD) 130C that can output a warning in the vehicle through a device disposed on the windshield of the vehicle or specifically mounted, etc.

The exterior output unit 140 can output a warning to another vehicle or an object outside the vehicle 100. For example, the exterior warning output unit 140 may include a horn 140A that can output a warning to the outside using a sound, a side mirror 140B that can be controlled to open and close by changing the angle, a lighting device 140C that can visually output a warning by turning on and off, etc. For example, the lighting device 140C may include a lamp, an indicator, a brake lamp, etc., but is not limited thereto.

An example of a method of preventing traffic accidents by means of the vehicle 100 to which the present disclosure has been applied is described hereafter with reference to the configurations of the short-range communication device 10 and the vehicle 10 described above.

FIG. 2 is a view illustrating a method of preventing a traffic accident when a vehicle an embodiment of the present disclosure is in park.

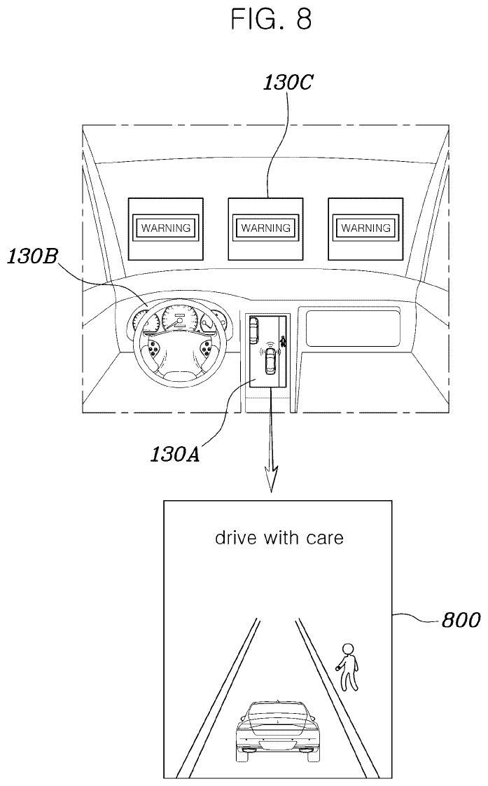

Referring to FIG. 2, the figure shows the situation in which a plurality of vehicles including the vehicle 100 to which an embodiment of the present disclosure has been applied are in park at a side of a lane 210 and a pedestrian 220 having the short-range communication device 10 is moving in the direction 230 crossing between the parked vehicles and entering the lane 210 ahead of a moving vehicle 240. When the vehicle 100 is in park or stopped at a side of the lane 210, as described above, a blind spot that the driver of the moving vehicle 240 cannot recognize may be made by the parked or stopped vehicle. In this case, the driver of the moving vehicle 240 cannot recognize the pedestrian 220 due to the blind spot, so a dangerous situation may occur. In this situation, the vehicle 100 according to an embodiment of the present disclosure senses the pedestrian 220 having the short-range communication device 10 and calls attention of the driver of the moving vehicle 240, etc. by outputting a warning signal through an output means to be described below with reference to FIGS. 8 to 13 such as a horn, a lighting device, and wireless communication, thereby being able to prevent a traffic accident due to the blind spot.

According to an embodiment of the present disclosure, the controller 120 can be operated by constant power or can maintain a wake-up state for a predetermined time even in an IG OFF state. In this case, even though the vehicle 100 is in park or stopped in the IG OFF state, the controller 120 can perform control for sensing an object carrying the short-range communication device 10 such as a surrounding pedestrian 220, determining whether a preset condition is satisfied, and outputting a warning.

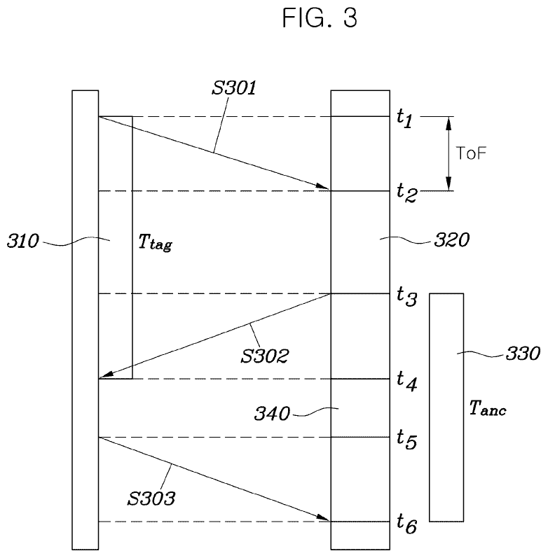

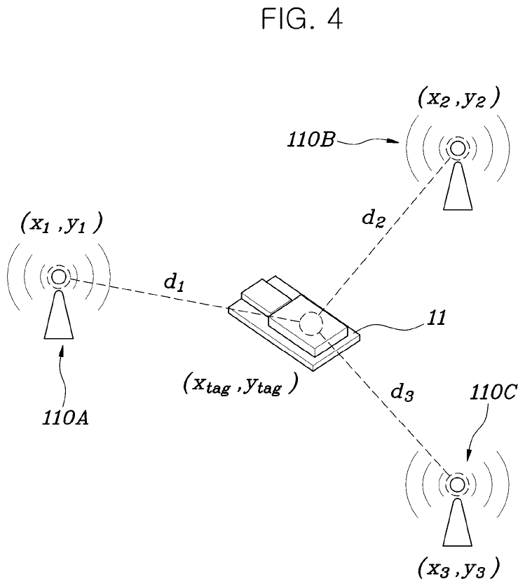

Hereafter, a method of determining the distance between the tag 11 and the anchor 110A and the position of the tag 11 by means of the controller 120 according to an embodiment is described with reference to FIGS. 3 and 4.

FIG. 3 is a view illustrating a method of determining the distance between a tag and an anchor by means of the controller 120 according to an embodiment.

Time-of-Flight (ToF) may mean the time that is taken for a signal to reach an arrival point from a start point. In the following description referring to FIGS. 3 and 4, ToF means the time that is purely taken for signal transmission when a signal is transmitted from a tag 11 to an anchor 110A or from the anchor 110A to the tag 11.

Referring to FIG. 3, a UWB signal is transmitted from a tag to an anchor (S301), the anchor transmits a UWB signal back to the tag in response to the signal (S302), and the tag transmits a UWB signal again to the anchor (S303). The tag can transmit and receive a signal one time through the three-time UWB signal transmission/reception process and the anchor also can transmit and receive a signal one time.

The total time Ttag 310 that is taken for the tag to transmit and receive a signal one time includes ToF t1˜t2 in transmission (S301), the processing time t2˜t3 320 of the anchor, and ToF t3˜t4 in reception S302. The processing time 320 of the anchor means the total time from the point in time t2 at which the anchor receives a signal from the tag to the point in time t3 at which the anchor transmits back a signal after processing the information, and may correspond to a preset sampling time for smooth real-time control. At the point of view of the tag, a pure signal reciprocation time is obtained by subtracting the processing time 320 of the anchor from the signal reciprocation consumption time Ttag 310 and corresponds to two times the ToF.

At the point of view of the anchor, the total time Ttag 320 for one-time transmission and reception of a signal includes the time t3˜t4 that is taken for the anchor to transmit a response signal and for the tag to receive the response signal 302, the processing time t4˜t5 340 of the tag, and the ToF t5˜t6 in reception S302. The processing time 340 of the tag means the total time from the point in time t4 at which the tag receives a response signal from the anchor to the point in time t5 at which the tag transmits back a final signal after processing the information, and may correspond to a preset sampling time for smooth real-time control. Accordingly, at the point of view of the anchor, a pure signal reciprocation time is obtained by subtracting the processing time 340 of the tag from the signal reciprocation consumption time (Tanc) 330 and corresponds to two times the ToF.

Accordingly, the controller 120 can determine the average time that is taken for signal transmission between the anchor and the tag as ToF by dividing the sum of the pure signal reciprocation time at the point of view of the tag and the pure signal reciprocation time at the point of view of the anchor by 4 that is the sum of the numbers of times of signal transmission and reception by the tag and the anchor. This is expressed as the following Equation 1.

$$[ Equation 1 ]$$

$$ToF = [ ( T tag - sampling time of an chor ) + ( Tan c - sampling time of tag ) ] / 4$$

When ToF is obtained, a distance can be obtained by multiplying the ToF by speed. Since the speed of a UWB signal corresponds to the speed of light, the distance between an anchor and a tag can be obtained as following Equation 2.

$$[ Equation 2 ]$$

$$distance between tag and anchor = c * ToF ( where c is the speed of light , about 300 , 000 km / sec )$$

Accordingly, the controller 120 can determine ToF from Equation 1 described above and can determine the distance between the tag 11 and the anchor 110A based on the ToF determined as in Equation 2. FIG. 4 is a view illustrating a method of determining the position and behavior of a tag through triangulation by means of a controller according to an embodiment.

The controller 120 can determine the position of a tag through triangulation using three or more anchors. Hereafter, a method of determining the position of a tag 11 based on a vehicle having three anchors 110A, 110B, and 110C, as exemplified in FIG. 1, is described. The controller 120 can obtain the distance between anchors as in following Equation 3. Assuming that the position of the first anchor 110A is (x1, y1), the position of the second anchor 110B is (x2, y2), and the position of the third anchor 110C is (x3, y3), the controller can determine the distance d1 from the first anchor 110A to the tag 11, the distance d2 from the second anchor 110B to the tag 11, and the distance d3 from the third anchor 110C to the tag 11. The controller 120 can determine the position (x_{tag}, y_{tag}) of the tag 11 based on d1, d2, and de through triangulation as in following Equation 4.

$$[ Equation 3 ]$$

$${d}_{k} = \sqrt{{( {x}_{k} - {x}_{f a g} )}^{2} - {( {y}_{k} - {y}_{f a g} )}^{2}}$$

$$[ Equation 4 ]$$

$$( {x}_{tag} , {y}_{tag} ) = {( {A}^{T} A )}^{- 1} {A}^{T} b$$

However, this is an example of methods of determining the position of a tag by means of the controller and it may be possible to determine the position of a tag based on Phase Difference of Arrival (PDOA) that determines the position of a tag by measuring the incident angle of a signal using only two anchors.

The behavior of an object may means the movement direction and speed of the object having the wireless communication device 10 including a tag 11 or movement path/pattern according to a combination thereof. For example, a movement direction of the tag 11 may be determined as displacement of the tag 11 for a preset minimum unit time and the movement speed of the tag 11 may be determined by dividing the displacement of the tag by the preset minimum unit time. Accordingly, the controller 120 can find out the behavior of the object based on the determined movement direction and speed of the tag 11.

Hereafter, a method of preventing a traffic accident using short-range wireless communication by means of the vehicle 100 to which the present disclosure has been applied based on the position and behavior of a tag 11 found out by the controller 120 is described.

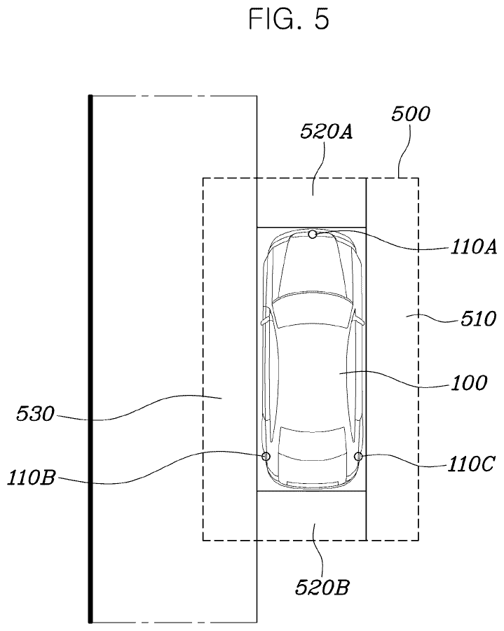

FIG. 5 is a view illustrating a method of determining surrounding danger area and safety area by means of a controller of a parked vehicle according to an embodiment.

Referring to FIG. 5, the controller 120 of a vehicle can determine a preset area 500 around the vehicle that is in park as a danger area and a safety area based on a preset reference. When the vehicle 100 to which an embodiment of the present disclosure has been applied is in part at the right side of a lane 210, the right part 510 of the area 500 around the vehicle may be determined as a safety area because no vehicle runs in the area, and the front part 520A, the rear part 520B, and the left part 130 of the vehicle may be determined as danger areas. For example, in the situation shown in FIG. 5, when an object enters the front area 520A of the vehicle that is a danger area or moves toward the lane 210 from the front area 520A of the vehicle (i.e., a preset reference is satisfied), the vehicle 100 can output a warning to at least one of the interior, the exterior, and the object.

The method of determining a danger area and a safety area and the preset reference described above are examples and may be differently applied, depending on the parking type of the vehicle 100, the traffic regulations (i.e., the pass directions of roads) of nations, etc.

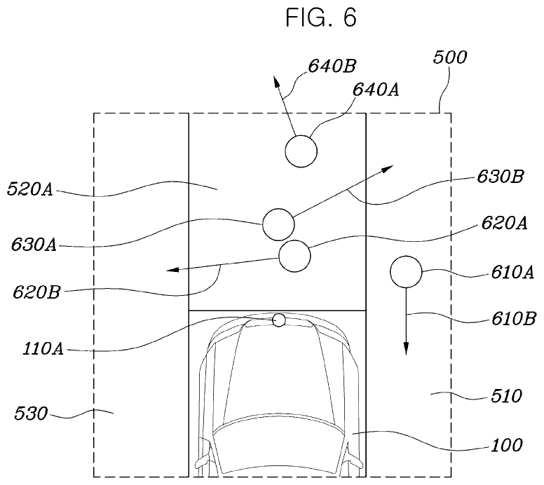

When a plurality of objects is sensed around the vehicle 100 to which the present disclosure has been applied, the controller 120 can determine the priority of the objects and can determine whether to output a warning in accordance with the determined priority. This is described with reference to FIG. 6.

FIG. 6 is a view illustrating a method of determining the priority of a plurality of objects around a vehicle by means of a controller according to an embodiment.

Referring to FIG. 6, it shows a situation in which a plurality of objects such as a first object 610A, a second object 620A, a third object 630A, and a fourth object 640A is positioned in the area 500 around a vehicle. The arrows 610B, 620B, 630B, and 640B indicate the behavior of the objects, respectively. The controller 120 can determine the priority of each of the objects using position and behavior information of each of the objects. For the convenience of description, the right is defined as +x direction and the front is defined as +y direction based on the first anchor 110A.

For example, when determining priority based on a position, the controller 120 can determine the objects in danger areas 520A and 53 of the plurality of objects as high priority and the object in a safety area 510 as low priority. In FIG. 6, since the first object 610A is in a safety area and the other second object 620A, third object 630A, and fourth object 640A are in a danger area, the controller 120 can determine the second object 620A, third object 630A, and fourth object 640A as higher priority than the first object 610A.

As another example, when determining priority based on behavior, the controller 120 can determine objects moving in the safety area 510 or moving in the +x-axial direction toward the safety area 510 from the danger area 520, such as the first object 610A, the third object 630A, and the fourth object 640A as low priority and can determine the second object 620A moving toward the danger area 520 from the safety area 510 or moving in the −x-axial direction toward the lane 530 from the danger area 520 as high priority.

According to an embodiment, the controller 120 can determine a danger level of an object based on at least one of the position, the behavior, and the priority of the object and can select the warning output type in accordance with a preset danger level reference. For example, when an object enters a danger area from a safety area, the controller can control output of a horn of the vehicle 100, and when an object moves in the −x-axial direction from a danger area, the controller 120 can control the flashing speed of hazard lights or side mirrors in proportion to the magnitude of the movement speed in the −x-axial direction in accordance with the magnitude of the movement speed in the −x-axial direction.

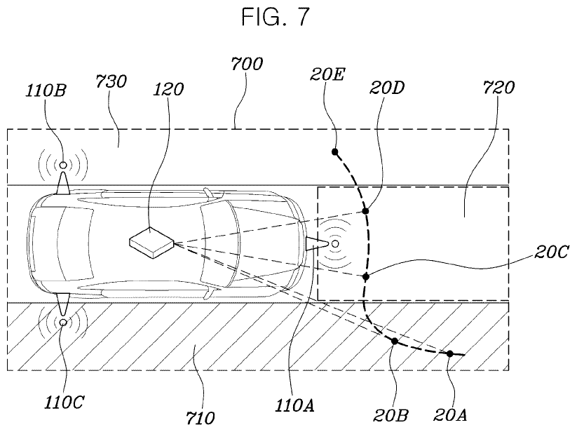

Safety areas and danger areas around a vehicle described with reference to FIGS. 5 and 6 are defined based on a parked or stopped vehicle in the above description, but they may be defined in other ways, depending on the state of a vehicle. This is described with reference to FIG. 7.

FIG. 7 is a view illustrating a method of determining a danger area and a safety area around a moving vehicle by means of a controller according to an embodiment.

FIG. 7 shows the situation in which the controller 120 of the present disclosure senses a plurality of objects 20A, 20B, 20C, 20D, and 20E having a tag around a moving vehicle area 700. As an example of determining danger areas around a vehicle when the vehicle 100 is moving, as shown in FIG. 7, when the vehicle 100 is moving on a last lane of which the right side area 710 is a sidewalk, the controller 120 can determine the front area 720 and the left area 730 of the lane in which the vehicle is moving as danger areas and the right side area 710 corresponding to the sidewalk as a safety area. In this case, the controller 120 can determine that only the objects 20C, 20D, and 20E in the front area 720 of the vehicle and the right area 730 of the vehicle of the plurality of objects having a tag satisfy a preset condition for output of a warning and the objects 20A and 20B in the right side area 710 of the vehicle do not satisfy the preset condition.

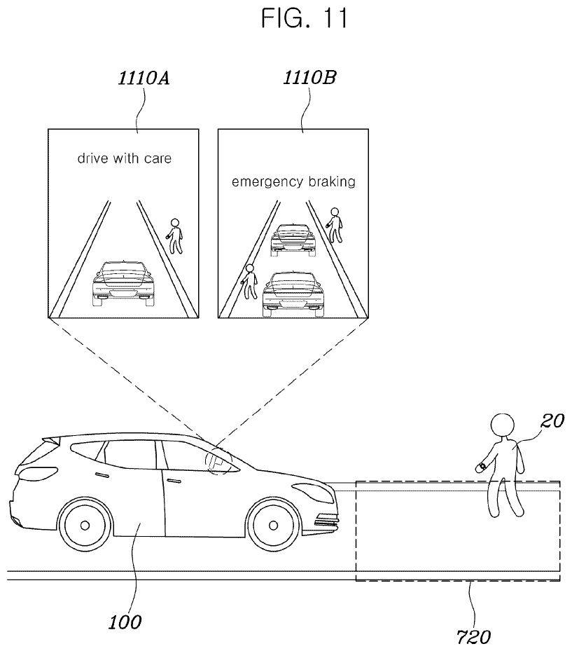

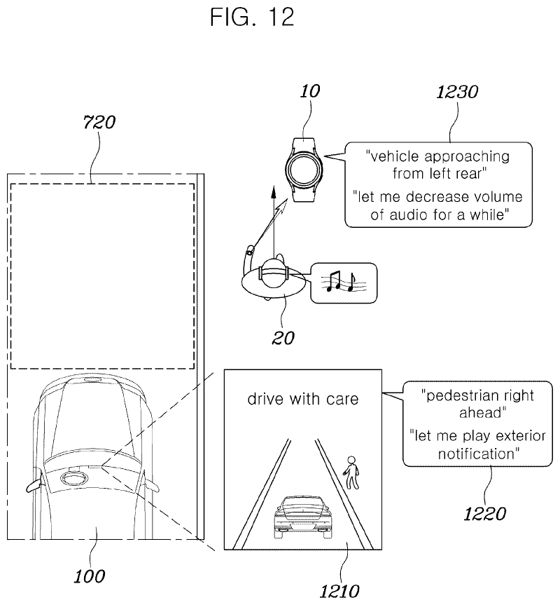

As another example, when the right side 710 of the lane in which the vehicle 100 is moving is another lane, the controller 120 can determine the front area 720 of the lane in which the vehicle is moving as a first-level danger area and can determine preset areas 710 and 730 (in this case, the right side area 710 is also included because the right area 720 is not a sidewalk) around the vehicle as second-level danger areas. In this case, when objects are in the first-level danger areas 710 and 730, such as the objects 20C and 20D, the controller 120 can control output of a warning corresponding to the first-level danger areas in accordance with the preset condition. When objects are in the second-level danger area 720, such as the objects 20A, 20B, and 20E, the controller 120 can perform control such that a warning corresponding to the second-level danger area is output in accordance with the preset condition or can perform control such that whether to output a warning is determined in consideration of the movement directions of the objects in accordance with the preset condition. The method of determining danger areas and the present conditions described above are examples and they may be differently applied, depending on the traffic regulations, etc. of nations. The detailed warning output type for each level is described below with reference to FIGS. 11 and 12.

Hereafter, a method of outputting a warning of a vehicle to which an embodiment of the present disclosure has been applied is described with reference to FIGS. 8 to 13.

FIG. 8 shows a method of outputting an interior warning in accordance with an embodiment of the present disclosure.

When determining that the present condition is satisfied, the controller 120 can perform control such that a warning is output to the interior of the vehicle 100. For example, the controller 120 can perform control such that a warning is output in types that the users in the vehicle can visually, aurally, etc. recognize through an AVN terminal 130A, a CLU 130B, an HUD 130C, etc. In more detail, the positions of the vehicle and objects can be shown (800) through the display of the AVN 130A. Together with this, a sound warning can also be output.

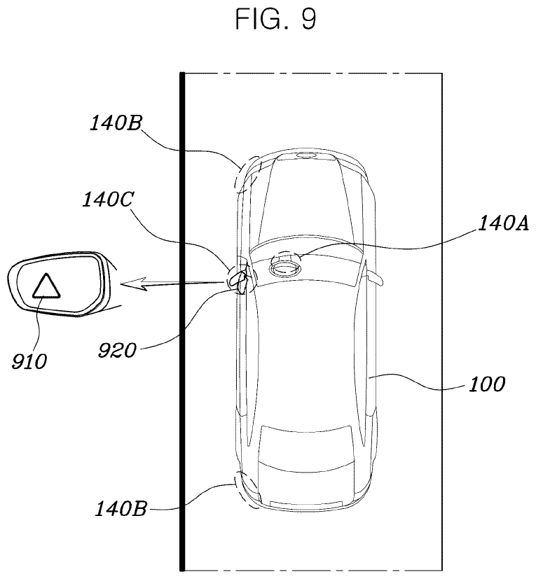

FIG. 9 shows a method of outputting an exterior warning in accordance with an embodiment of the present disclosure.

When determining that the present condition is satisfied, the controller 120 can perform control such that a warning is output to the exterior of the vehicle 100.

For example, the controller 120 can output a warning to an object 20 outside the vehicle 100 or the drivers of other vehicles by controlling a horn 140A of the vehicle.

As another example, the controller 120 can perform control such a warning is output to the exterior by controlling a flashing light of the lighting device 140B. In this case, the lighting device 140B can be controlled to output a warning by turning on/off an indicator in accordance with the movement direction of the object. In this case, the controller 120 may control the flashing speed of indicators or hazard lights such that the flashing speed is proportional to the movement speed of the object.

As another example, the controller 120 can perform control such that a warning is output to the exterior by controlling the side mirrors 140C. In detail, when there is a light 910 at side mirrors, the controller 120 can control flashing of the lights 190 of the side mirrors or change the angles 920 of the side mirrors 140C.

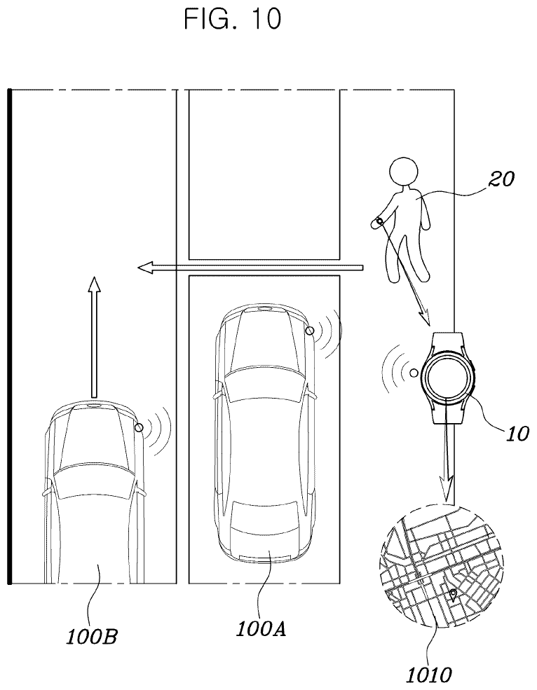

FIG. 10 shows a method of requesting output of a warning to a surrounding object by means of a vehicle according to an embodiment.

Referring to FIG. 1, when the controller 120 of a parked vehicle 100A determines that an object 20 satisfies a preset warning condition, the controller 120 can perform control to request the short-range communication device 10 of the object 20 to output a warning. In this case, the short-range communication device 10 can receive the request for outputting a warning from the vehicle and output a warning through a display 1010 or using a sound.

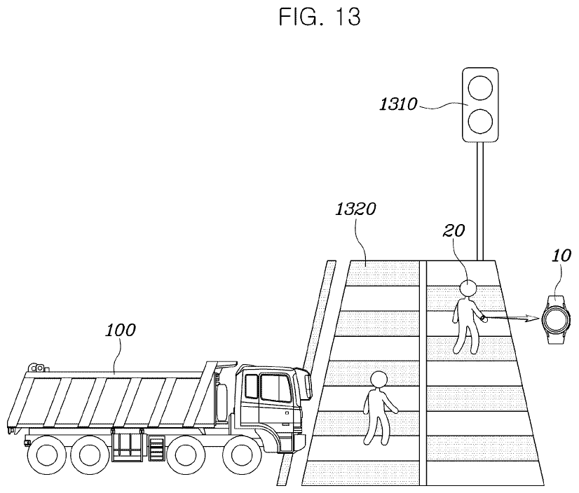

The controller 120 may request even a surrounding vehicle 100B or infrastructures (e.g., a traffic light in FIG. 13 to be described below) to output a warning other than the object 20 having the short-range communication device 10. For example, when the controller 120 of a parked vehicle 100A determines that an object 20 satisfies a preset warning condition, the controller 120 can perform control to request even a surrounding moving vehicle 100B to output a warning. Embodiments are not limited to the type of outputting a warning to the surrounding moving vehicle 100B.

FIG. 11 is view illustrating a method of outputting a warning when there is an object in front of a vehicle according to an embodiment when the vehicle is moving.

Referring to FIG. 11, it shows the situation in which an object 20 is in the front area 720 of a moving vehicle 100. When the controller 10 of the moving vehicle 100 recognizes the object 20 in the front area 720, the controller 120 can control a request for outputting a warning to the interior and exterior of the vehicle 100 and the object.

For example, the controller 120 can request the AVN terminal 130A or the CLU 130B to output a warning image 1110A. As another example, the controller 120 can request emergency braking to the brake system of the vehicle. In this case, the controller 120 can perform control such that an emergency braking information image 1110B is output.

FIG. 12 is view illustrating a method of outputting a warning when there is an object around a vehicle according to an embodiment when the vehicle is moving.

Referring to FIG. 12, it shows the situation in which there is an object 20 in the right side area 710 of the area 700 around a moving vehicle 100. In this situation, the controller 120 of the moving vehicle 100 can control an interior display such as the AVN terminal 130 and the CLU 130B to output a warning image 1210 and a sound device to output a warning voice 1220. According to an embodiment, the controller 120 of the moving vehicle 100 can perform control to request the short-range communication device 10 of the object 20 to output a warning and the short-range communication device 10 can output a warning voice 1230.

FIG. 13 is a view illustrating a method of requesting a traffic light to output a warning by means of a vehicle according to an embodiment.

Referring to FIG. 13, it shows the case in which the vehicle 100 to which the present disclosure has been applied senses an object 20 passing a crosswalk 1320 with a traffic light 1310 while moving. In this case, it may be difficult to the driver of a vehicle with a large vehicle height to recognize a pedestrian passing by ahead of the vehicle due to a blind spot of the vehicle. In particular, when a pedestrian is short such as a child or an elder, there is a problem that it is difficult for the driver of a vehicle with a large vehicle height to recognize such an object 20. Further, since children and elders move slowly, they have difficulty in passing a crosswalk within a general time of the signal in many cases. Therefore, according to an embodiment of the present disclosure, when an object is sensed around a crosswalk 1320, the vehicle 100 can transmit a warning output request signal to a traffic light 1310 and the traffic light 1310 can generate a warning that the object 20 is passing the crosswalk 1320 to the surrounding using a voice or a visual means in accordance with the warning output request signal and can extend the time of the crosswalk signal until the object 20 completely passes the crosswalk 1320. According to another embodiment, the traffic light 1310 may sense an object 20 and extend the time of the traffic light or output a warning to the surrounding.

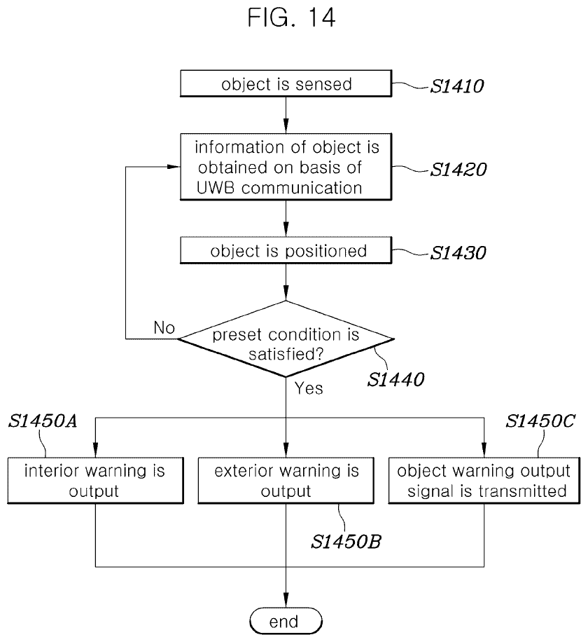

The method of preventing a traffic accident according to an embodiment of the present disclosure described above is shown in a flowchart in FIG. 14.

FIG. 14 is a flowchart showing an example of a method in which a vehicle according to an embodiment senses an object and prevents a traffic accident.

Referring to FIG. 14, a vehicle 100 can sense an object having a tag around the vehicle by receiving a UWB communication signal through anchors 110A, 110B, and 110C (1410).

The controller 120 of the vehicle can obtain information of the object 20 from the received UWB communication signal (S1420). For example, as described above with reference to FIG. 3, the controller 120 can determine the distance between each of the anchors and the tag based on ToF.

The controller 120 can perform positioning on the object based on the determined distances (S1430). In detail, triangulation described above with reference to FIG. 4, etc. may be used for positioning.

The controller can determine whether a preset condition for outputting a warning is satisfied based on the position information of the object determined through positioning, etc. (S1440). The preset condition may include whether an object moves into a danger area around the vehicle 100, behavior from a danger area, etc., but these are examples and the present disclosure is not necessarily limited thereto.

When determining that the preset condition is not satisfied (No in S1440), the controller 120 can obtain again the information of the surrounding sensed object and update the position and speed information. When determining that the preset condition is satisfied (Yes in S1440), the controller 120 can perform at least one of outputting of a warning to the interior of the vehicle (S1450A), outputting of a warning to the exterior of the vehicle (S1450B), and transmitting of a warning output signal to the object (S1450C). The detailed types of outputting of a warning are similar to those described above with reference to FIGS. 8 to 13, so repeated description is omitted.

In the related art, when there is a vehicle parked or stopped at a side on a road, a blind spot may be made by the parked or stopped vehicle. Accordingly, the driver of a moving vehicle may not recognize a pedestrian moving toward the vehicle across between the parked of stopped vehicle due to the blind spot, so a dangerous situation may occur. In particular, children and elders are short in comparison to parked vehicles in many cases, so there is a problem that even though the driver of a moving vehicle sufficiently carefully drives, it is difficult to recognize children or elders hidden by parked or stopped vehicles.

However, a vehicle 100 to which an embodiment of the present disclosure has been applied and a method of controlling the vehicle can prevent traffic accidents by recognizing an object having a short-range communication device 10 through short-range wireless communication and outputting a preset warning to surrounding derivers, pedestrians, etc. In particular, when using an UWB communication protocol, it is possible to perform precise positioning around 10 cm on an object and it is possible to perform precise positioning on a plurality of objects because influence by interference is low, so it is possible to more accurately recognize objects and output a warning.

The present disclosure can be achieved as computer-readable codes on a program-recoded medium. A computer-readable medium includes all kinds of recording devices that keep data that can be read by a computer system. For example, the computer-readable medium may be an HDD (Hard Disk Drive), an SSD (Solid State Disk), an SDD (Silicon Disk Drive), a ROM, a RAM, a CD-ROM, a magnetic tape, a floppy disk, and an optical data storage. Accordingly, the detailed description should not be construed as being limited in all respects and should be construed as an example. The scope of the present disclosure should be determined by reasonable analysis of the claims and all changes within an equivalent range of the present disclosure are included in the scope of the present disclosure.

What is claimed is:

1. A method of controlling a vehicle, the method comprising:
sensing whether there is an object, which can be positioned, around a subject vehicle based on a short-range wireless communication protocol that supports spatial positioning or direction recognition; and
in response to sensing an object around the subject vehicle, determining whether at least one of position and behavior of the sensed object satisfies a preset warning condition.

2. The method of claim 1, further comprising outputting a warning to an interior or an exterior of the subject vehicle or to a surrounding object in response to satisfying the preset warning condition.

3. The method of claim 2, wherein the outputting of a warning to an interior comprises outputting a warning through at least one of a display or a sound device of the subject vehicle.

4. The method of claim 2, wherein the outputting of a warning to an exterior comprises outputting a warning by controlling at least one of a mirror, a lighting device, or a horn of the subject vehicle.

5. The method of claim 2, wherein the outputting of a warning to a surrounding object comprises transmitting a warning output request signal to at least one of the sensed objects, a surrounding vehicle, or a surrounding traffic light based on the communication protocol of the subject vehicle.

6. The method of claim 1, wherein the short-range wireless communication protocol comprises Ultra-Wide Band (UWB).

7. The method of claim 6, wherein the object has a UWB tag and the subject vehicle has one or more UWB anchors.

8. The method of claim 1, wherein the sensing further comprises:
determining priority in accordance with a preset reference based on position and behavior of a plurality of objects in response that the plurality of objects is sensed; and
determining whether the preset warning condition is satisfied based on an object having highest priority.

9. The method of claim 1, wherein the preset warning condition is satisfied in at least one case of in response that the object moves from a preset safety area around the subject vehicle toward a preset danger area around the subject vehicle, in response that the object is in the danger area, or in response that the object moves toward a lane from the danger area.

10. The method of claim 1, further comprising instructing the subject vehicle to brake in response that the preset warning condition is satisfied.

11. A vehicle comprising:
a communication terminal configured to sense whether there is an object, which can be positioned, around the vehicle based on a short-range wireless communication protocol that supports spatial positioning and direction recognition; and
a controller configured to, in response that an object is sensed around the vehicle, determine whether at least one of position and behavior of the sensed object satisfies a preset warning condition.

12. The vehicle of claim 11, further comprising an output unit,
wherein the controller is further configured to perform control such that a warning is output to an interior or an exterior of the vehicle or the warning is output to the object through the output unit in response that the preset warning condition is satisfied.

13. The vehicle of claim 12, wherein the output unit comprises at least one of a display or a sound device provided in the interior of the vehicle.

14. The vehicle of claim 12, wherein the output unit comprises at least one of a mirror, a lighting device, or a horn provided on the exterior of the vehicle.

15. The vehicle of claim 12, wherein the communication terminal is further configured to output a warning output request signal to the sensed object based on the communication protocol.

16. The vehicle of claim 11, wherein the short-range wireless protocol comprises Ultra-Wide Band (UWB).

17. The vehicle of claim 16, wherein the object has a UWB tag and the vehicle has one or more UWB anchors.

18. The vehicle of claim 17, wherein in response that a plurality of objects is sensed, the controller is further configured to determine priority in accordance with a preset reference based on position and behavior of each of the plurality of objects and determine whether the preset warning condition is satisfied based on an object having highest priority.

19. The vehicle of claim 11, wherein the controller is further configured to divide a surrounding of the vehicle into a danger area and a safety area and determine that the preset warning condition is satisfied in at least one case of in response that the object moves toward the danger area from the safety area, in response that the object is in the danger area, or in response that the object moves toward a lane from the danger area.

20. The vehicle of claim 11, wherein the controller is further configured to sense the object in response that the vehicle is in stop or park and determine whether the preset warning condition is satisfied for the sensed object.
